(19) United States
(12) Patent Application Publication
(10) Pub. No.: US 2006/0237349 A1
(43) Pub. Date: Oct. 26, 2006

(54) Secure collection of rejected articles

(76) Inventor: Michael Thomas Solomon, Carbondale, IL (US)

Correspondence Address: THOMSON LICENSING INC., PATENT OPERATIONS, PO BOX 5312, PRINCETON, NJ, 08543-5312, US

(21) Appl. No.: 11/111,171

(22) Filed: Apr. 21, 2005

(51) Int. Cl. B07C 5/00

(52) U.S. Cl. 209/509

(57) ABSTRACT

A system and method for segregating objects, including an inspection system that automatically inspects a plurality of objects to identify objects having at least one particular characteristic. The object selection apparatus automatically selects the identified object based on the characteristic and deposits the identified object into a limited access storage container. In particular, an object chute transfers the identified object from the object selection apparatus to the storage container. The limited access storage container can be a removable bin. The inspection system can include at least one sensor, such as an inspection camera, for inspecting the objects.

### FIELD OF THE INVENTION

The present invention relates generally to automated manufacturing systems and, more particularly, to defect segregation systems.

### BACKGROUND OF THE INVENTION

There are a number of techniques which are presently used for making optical discs, such as compact discs (CDs) and digital versatile discs (DVDs), which contain data. One technique commonly used for high volume production is optical disc molding. In optical disc molding, data to be imprinted on the optical discs is contained in a metal stamp, or master. To form each optical disc, molten polycarbonate is injected into a disc mold and compressed against the metal stamp to form the pit impressions which are readable as data by an optical disc player. Oftentimes disc identification information is embedded into each disc during the molding process. Such information can be in the form of a bar code and/or identifier code which indicates an order number or other desired identification information.

After the discs are molded, the discs are typically sent to a printing machine to receive screen printing and offset printing. The printing machine will typically include a bar code/identifier code reader to verify that the discs being printed are the correct discs. Additionally, the screen printing machine can inspect the printing quality and other disc parameters, for example physical parameters of discs. Discs which have the wrong bar codes, identifier codes, are not properly printed, or fail other parameters are rejected by the printing machine and placed on a reject spindle.

Discs placed on the reject spindle should be discarded. However, production personnel sometimes attempt to salvage rejected discs to minimize scrap and maximize production yields. Unfortunately, such salvaged discs oftentimes have defects which are unacceptable to a paying consumer. Moreover, discs having different identifier codes and containing different content sometimes are inadvertently mixed prior to being placed in the screen printer. In consequence, some of these discs are incorrectly screen printed and packaged. For instance, a particular DVD may be screen printed and packaged as a particular movie, but the DVD may actually contain a different movie. Not only will such a disc anger a paying customer who wishes to own the movie they believe they have purchased, the disc also may violate certain copyright laws.

### SUMMARY OF THE INVENTION

The present invention relates to a system and method for segregating objects, including an inspection system that automatically inspects a plurality of objects to identify objects having at least one particular characteristic. The object selection apparatus automatically selects the identified object based on the characteristic and deposits the identified object into a limited access storage container. In particular, an object chute transfers the identified object from the object selection apparatus to the storage container. The limited access storage container can be a removable bin. The inspection system can include at least one sensor, such as an inspection camera, for inspecting the objects.

The invention can further include a disc screen printer with an inspection system that automatically inspects the discs to identify discs having at least one particular characteristic. The object selection apparatus then automatically selects the identified disc based on the characteristic and deposits the identified disc into a limited access storage container. An object chute transfers the disc from the object selection apparatus to the storage container. The limited access storage container can be a removable bin. The inspection system can include at least one sensor, such as an inspection camera, for inspecting the objects. The automatically inspecting step can include identifying a defect in the objects and, more particularly, can include visually inspecting the objects. The identified object can be automatically stored in a container to which access is limited to authorized personnel.

### BRIEF DESCRIPTION OF THE DRAWINGS

Preferred embodiments of the present invention will be described below in more detail, with reference to the accompanying drawings, in which:

FIG. 1 is a top view of an object segregation system which is useful for understanding the present invention.

FIG. 2 is a perspective view of an object unloading station and storage container which are useful for understanding the present invention.

FIG. 3 is a perspective view of the object unloading station and storage container of FIG. 2 in which access to the storage container is limited.

FIG. 4 is a partial perspective view of an alternate embodiment of the storage container of FIG. 2.

FIG. 5 is a perspective view of the storage container of FIG. 4 in which access to a storage container is limited.

### DETAILED DESCRIPTION

The present invention relates to a system for segregating objects, for example manufactured items. The invention includes an inspection system that automatically inspects each of a plurality of objects to identify objects having a particular characteristic, such as improper labeling or physical defects. The invention also includes an object selection apparatus that automatically selects the identified objects, and a limited access storage container into which the identified objects are deposited for storage. Advantageously, the limited access storage container prevents unauthorized access to rejected items that have been removed from a production or packaging process, thereby minimizing the risk of rejected items being salvaged and commercially distributed.

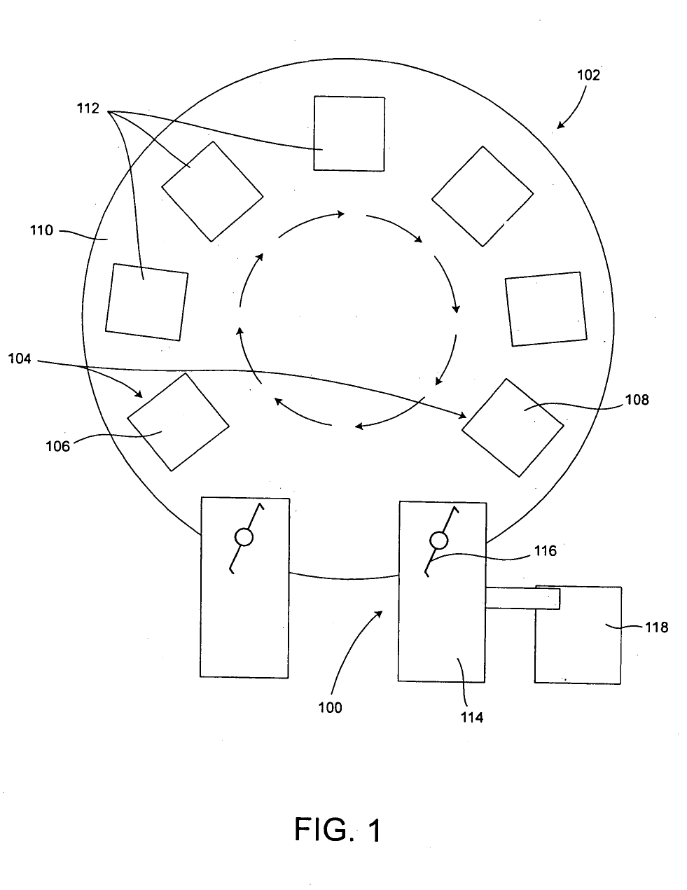

Referring to FIG. 1, a top view of an object segregation system 100 is depicted. The object segregation system 100 can be incorporated in a manufacturing system. For example, the object segregation system 100 can be incorporated into a disc printing apparatus 102, but the invention is not limited in this regard. Indeed, the object segregation system 100 can be incorporated into any manufacturing and/or packaging system requiring segregation of certain objects, for instance objects which do not meet quality assurance inspection criteria.

The object segregation system 100 can include an inspection system 104. The inspection system 104 can include sensors which capture data pertaining to the objects and identify certain ones of the objects that have at least one particular characteristic. The characteristic can be a manufacturing, labeling or packaging defect, or any other characteristic which may be automatically inspected. For example, the inspection system 104 can comprise an identification inspection camera 106 to inspect bar coding and serial numbering applied to compact discs (CDs) or digital versatile discs (DVDs)—hereinafter collectively referred to as discs—, and a print inspection camera 108 to inspect screen printing applied to the discs. Such cameras are known to those skilled in the art. It should be noted that the invention is not limited in this regard, however, and the inspection system 104 can include sensors that measure other parameters as well. For instance, the inspection system can include x-ray scanners, thermal imagers, etc. One or more processors (not shown) and suitable software and/or firmware also can be provided to process data collected by the sensors.

In operation, the object segregation system 100 can transport the objects to be inspected past the inspection system 104. For instance, the discs can be loaded onto a carrousel 110 that not only transports the discs to print stations 112, but also transports the discs to the inspection cameras 106,108 and to an unloading station 114. The unloading station 114 can include an object selection apparatus 116 and a limited access storage container 118. The object selection apparatus 116 can automatically select objects identified by the inspection system 104 as having a particular characteristic, such as being damaged or incorrectly marked, and deposit the selected objects into the storage container 118. The unloading station 114 can forward the remaining objects on for further processing and/or packaging.

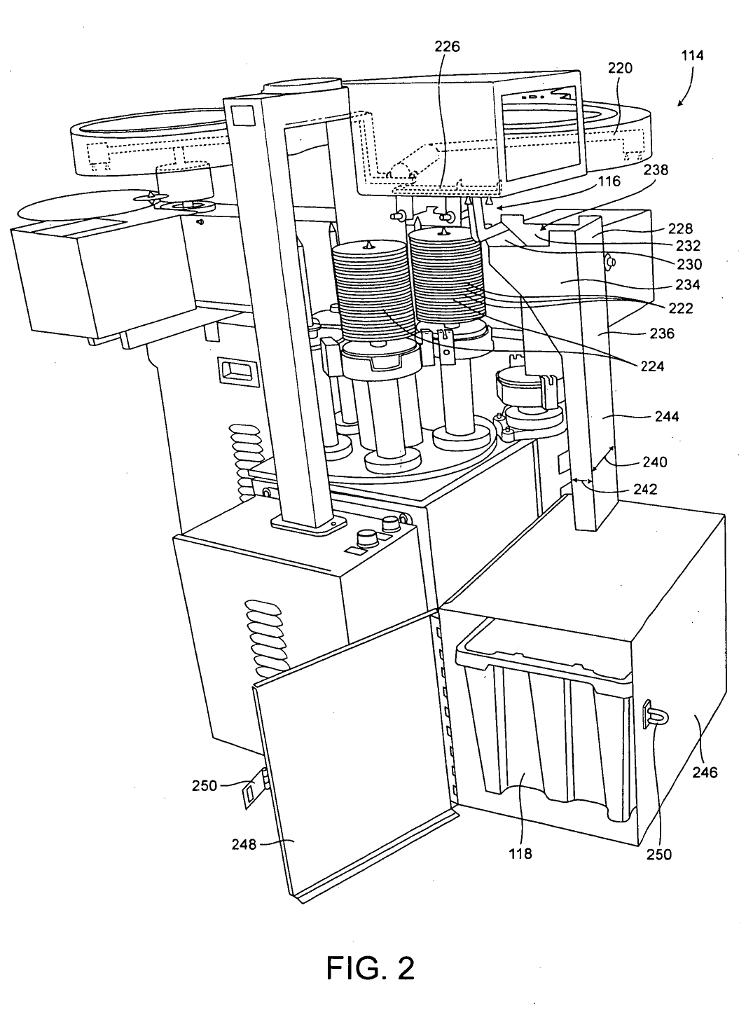

A perspective view of the unloading station 114, object selection apparatus 116 and storage container 118 is shown in FIG. 2. The object selection apparatus 116 can include an unloading arm 220 that unloads objects, such as discs 222, from the carrousel (not shown in FIG. 2) and arranges the objects for further processing, such as packaging. For example, the discs 222 can be arranged in stacks 224, as shown.

The object selection apparatus 116 also can include an object reject arm 226 that places objects that have the particular characteristic into the storage container 118. For example, the object reject arm 226 can remove the rejected discs from the unloading arm 220 and drop the rejected discs into the storage container 118 via chute 228. As shown, the chute 228 can be configured to receive rejected discs and transport the discs into the storage container 118 using gravity. However, the invention is not limited in this regard. For example, a mechanical and/or electrical transport mechanism can be integrated into chute 228.

The chute 228 can comprise one or more surfaces 230, 232, 234, 236 which define an opening 238 for receiving objects and define a path to guide the objects into the storage container 118. In particular, a width 240 and depth 242 of the chute 228 can be optimized to facilitate transport of the rejected objects. For instance, the width 240 can be greater than a diameter of the discs 222 and the depth 242 can be greater than a thickness of the discs 222. As shown, dimensions of the opening 238 are larger than the width 240 and depth 242 of a lower portion 244 of the chute 238, however, the invention is not limited in this regard.

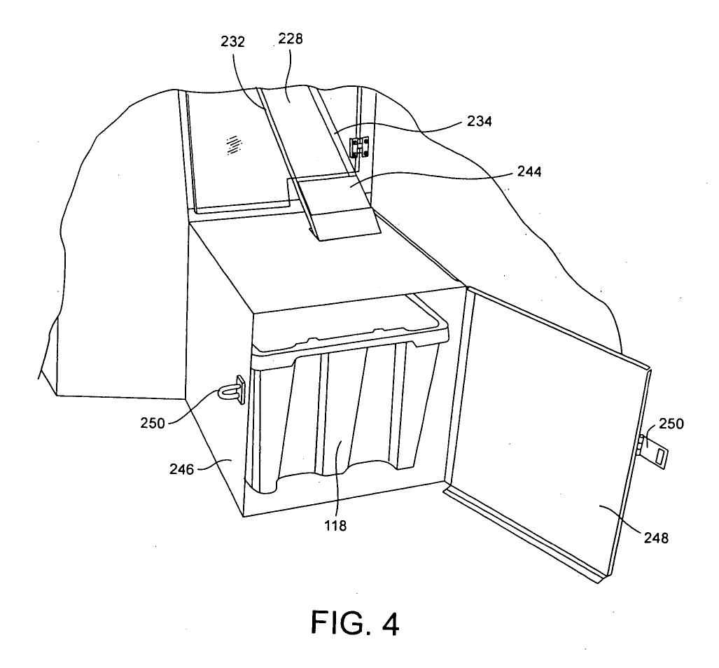

According to one embodiment of the present invention, the chute 228 can be oriented such that the chute is substantially vertical to facilitate movement of the objects through the chute 228. In another arrangement, such as that shown in FIG. 4, the chute 228 can be oriented at an angle with respect to vertical. In this embodiment the chute 228 the surface 244 need not extend an entire length of the chute 228 as gravity can maintain objects between surfaces 232, 234 while the objects are transported through the chute 228. In yet another embodiment, the surface 244 can be eliminated altogether.

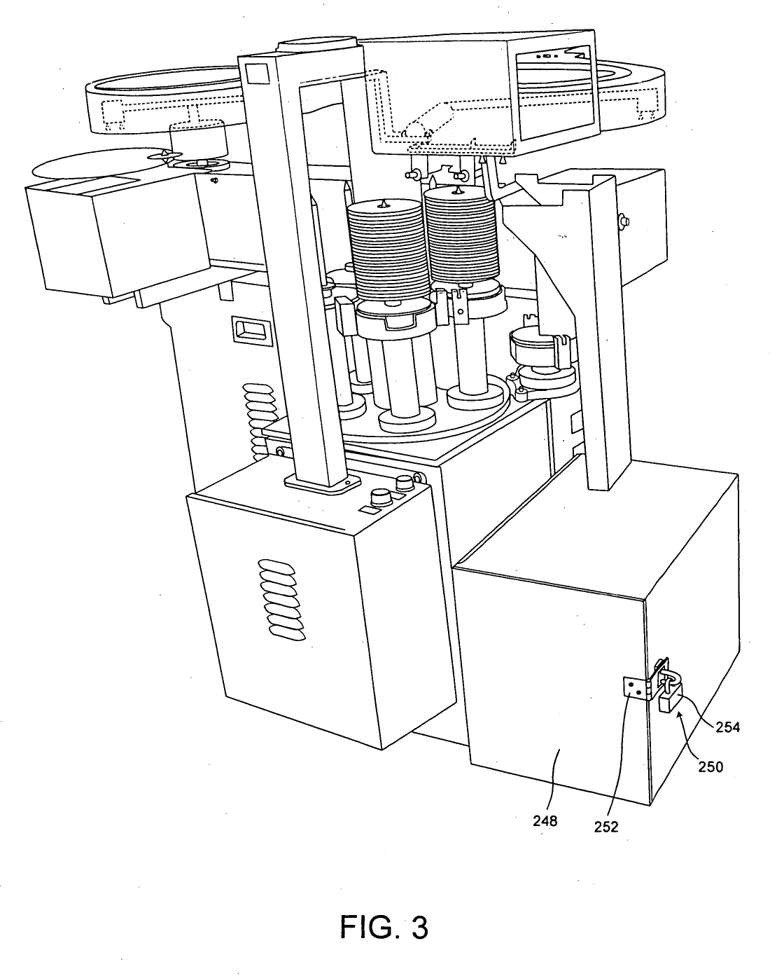

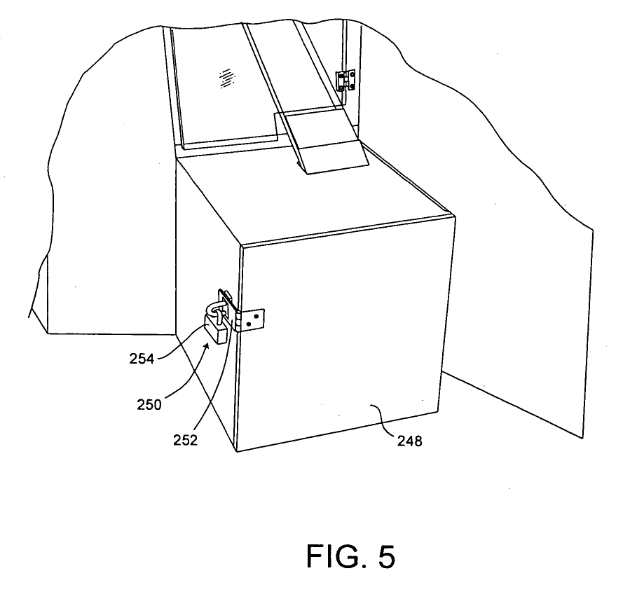

Referring both to FIGS. 2 and 4, the storage container 118 can be located within a limited access enclosure 246, thereby providing limited access to the storage container 118. For example, the storage container 118 can be a removable bin that is placed within the limited access enclosure 246. The enclosure 246 can, for example, include a hinged door 248 and a locking apparatus 250. When it is desired that the storage container 118 be inaccessible to particular individuals, the hinged door 248 can be closed and the locking apparatus 250 can be activated, as shown in FIGS. 3 and 5. For instance, a clasp 252 can be closed and a padlock 254 can be installed onto the clasp. Nonetheless, the invention is not limited in this regard and any other means of limiting access to the storage container 118 can be used. For example, a combination lock or time lock can be used to lock the door 248 in the closed position. Accordingly, access to objects placed in the storage container can be limited to authorized persons only and/or limited to access at certain times, thus reducing the risk of rejected objects being removed from the storage container and being salvaged and commercially distributed.

While the foregoing is directed to the preferred embodiment of the present invention, other and further embodiments of the invention may be devised without departing from the basic scope thereof, and the scope thereof is determined by the claims that follow.

1. A system for segregating objects, comprising:
an inspection system that automatically inspects each of a plurality of objects to identify at least one of said plurality of objects having at least one particular characteristic;
an object selection apparatus that automatically selects said identified object based on the characteristic; and
a limited access storage container into which said identified object is deposited for storage.

2. The system of claim 1, further comprising an object chute which transfers said identified object from said object selection apparatus to said storage container.

3. The system of claim 1, wherein said limited access storage container comprises a removable bin.

4. The system of claim 1, wherein said inspection system comprises at least one sensor for inspecting said plurality of objects.

5. The system of claim 4, wherein said at least one sensor is an inspection camera.

6. A disc screen printer, comprising:
an inspection system that automatically inspects each of a plurality of discs to identify at least one of said plurality of discs having at least one particular characteristic;
an object selection apparatus that automatically selects said identified disc based on the characteristic; and
a limited access storage container into which said identified disc is deposited for storage.

7. The disc screen printer of claim 6, further comprising an object chute which transfers said identified disc from said object selection apparatus to said storage container.

8. The disc screen printer of claim 6, wherein said limited access storage container comprises a removable bin.

9. The disc screen printer of claim 6, wherein said inspection system comprises at least one sensor for inspecting said plurality of objects.

10. The disc screen printer of claim 9, wherein said at least one sensor is an inspection camera.

11. A method for segregating objects, comprising:
automatically inspecting each of a plurality of objects to identify at least one of said plurality of objects that has at least one particular characteristic;
automatically selecting said identified object based on the characteristic; and
automatically storing said identified object in a container to which access is limited.

12. The method of claim 11, wherein said automatically inspecting step further comprises identifying a defect in said at least one object.

13. The method of claim 11, wherein said automatically selecting step further comprises visually inspecting said plurality of objects.

14. The method of claim 11, wherein said automatically storing step comprises placing said identified object into a locked container.
